(19) United States
(12) Patent Application Publication
(10) Pub. No.: US 2026/0134077 A1
(43) Pub. Date: May 14, 2026

(54) Method for managing authentication data allowing a user to access a service from a terminal

(71) Applicant: ORANGE, Issy-les-Moulineaux (FR)

(72) Inventor: Ghislain Moncomble, Chatillon (FR)

(21) Appl. No.: 19/118,931

(22) PCT Filed: Oct. 10, 2023
(86) PCT No.: PCT/EP2023/078094

§ 371 Date: Apr. 7, 2025

(30) Foreign Application Priority Data
Oct. 11, 2022 (FR) FR2210381

(51) Int. Cl. G06F 21/34

(52) U.S. Cl. CPC G06F 21/34

(57) ABSTRACT

A method for managing authentication data allowing a user to access a service from a terminal. The access of a user requires authentication data to be provided to the service. The method includes the terminal requesting a device which is separate from the terminal to store authentication data of a user for the service, followed by providing the authentication data by using the device.

### CROSS-REFERENCE TO RELATED APPLICATIONS

This Application is a Section 371 National Stage Application of International Application No. PCT/EP2023/078094, filed Oct. 10, 2023, and published as WO 2024/079144 A1 on Apr. 18, 2024, not in English, which claims priority to and the benefit of French Patent Application No. 2210381, filed Oct. 11, 2022, the contents of which are incorporated herein by reference in their entireties.

### TECHNICAL FIELD

The technical field is that of authentication of users of a service.

More precisely, the invention relates to a method for managing authentication data allowing access to a service by a user from a terminal. Such a method will potentially be used to manage the authentication data of a plurality of users wishing to access distinct services. However, one feature of the invention is that the terminal allowing users access to the services is capable of being shared between a plurality of users.

The services in question are for example web services intended for individuals or professionals. The authentication data in question will then in most cases be identifiers and passwords, but may also be biometric data, depending on the mode of authentication used by the services, or any other datum useful for authentication, such as authentication tokens for example. Other methods of connecting users to the services other than a connection according to the HTTP protocol are possible. Hence reference will not be made to web services but the authentication required to access the service will always be achieved from the terminal, through submission, to the service, of authentication data specific to the user of the service, such as a pair composed of an identifier and of a password.

Users will authenticate themselves to the service from a terminal. It may for example be a laptop or desktop computer, but may also be a tablet or indeed a smartphone. The authentication of the user by a service is then achieved through submission of an identifier and then a password. In general, users may want to sign into various services from the same terminal. The same user will therefore have different authentication data depending on the service.

Because a user may want to sign into many services, there is a need to manage authentication data, as otherwise the user must rely entirely on her or his memory to do so. Moreover, since the authentication data make it possible to sign into a service that may give access to confidential data or functions, the management of these authentication data must be secure.

### PRIOR ART

A well-established method for managing authentication data is the creation of a password safe. Such a safe is a software application that will record in a terminal a set of authentication data, in the form of identifier-password pairs. Other data may optionally be recorded. Authentication data may also be stored in a file or disk space of a computer, and access to it protected by a password. Authentication tokens are also stored in secure memory areas.

Such a safe will typically take the form of a module of a web browser. Thus, when a user creates an account for a service and the associated authentication data via the web browser, the module dedicated to managing authentication data will be able to store the latter in the terminal in which the web browser is running. This storage in the terminal may be carried out by using cryptography techniques to protect the authentication data and ensure secure management thereof. When a user attempts to authenticate themselves to a web service through the browser, authentication data already having been saved for said service, the browser module dedicated to managing authentication data will be able to provide the password stored in the terminal in order to facilitate authentication of the user. This provision will possibly be carried out after decryption if the password has been recorded in the terminal in encrypted form to ensure the security of the authentication data.

This technology is now well established but has a major drawback when a plurality of users use the same shared terminal to sign into one or more services. This situation may occur in a number of contexts. For example, in a domestic context, a single computer or tablet, or even a single smartphone, may be used by all the members of a family to sign into services requiring user authentication, such as social networks or e-commerce sites. Furthermore, in a business context, a plurality of employees based at the same business location, for example salespeople in a boutique, or mechanics in a repair shop, may share a single computer allotted to the business location to access business applications requiring user authentication. Because it is not possible to guarantee that each user will sign out after interacting with the shared terminal, another user may be able to access data allowing authentication to the services.

In both these domestic and business contexts, access to services implies a need for confidentiality. A user must be unable to learn the authentication data of another user, or must be unable to use the data of another user to sign in to a service using her of his appropriated identify. However, a web-browser module playing the role of password safe does not meet this requirement, because it is impossible to guarantee that each user will sign out after having used a shared terminal. Specifically, nothing prevents a user from consulting the authentication data of all the users, which data are stored by the web browser of the terminal shared by the various users. These authentication data may either be read or even used directly for authentication. In this case, a user may impersonate any user with whom the terminal is shared, and with whom the browser and the browser module that serves as a password safe are therefore shared.

Another drawback of the existing technology is that it is unsuitable when a user has access to a plurality of terminals. When the authentication data of a user are stored in a password safe or in a dedicated file or disk space, these data are present only on a single terminal. When the user changes terminal, she or he cannot in principle access the authentication data stored in another device.

The invention aims to improve the situation.

### SUMMARY

According to a first functional aspect, the invention relates to a method for managing authentication data allowing access to a service by a user from a terminal, access by a given user to a service requiring the service to be provided with authentication data relating to said user, which method is characterized in that it comprises a step of said terminal requesting that a device separate from the terminal store authentication data of a user for the service followed by a step of the device providing the stored authentication data of the given user for the service.

According to a first particular mode of implementation of the invention, the step of the device providing the stored authentication data of the given user for the service is preceded by: a request by a given user to access the service from the terminal; a step of the device receiving a request to obtain authentication data of the user for the service; and a validating step performed by the user on the device.

By virtue of the invention, the user needs no longer memorize the authentication data allowing them to access the service. These, following a request from the terminal, are stored by a device separate from the terminal. These data will then be provided, which will allow the user to access the service from the terminal. In a first embodiment, the data are provided after a validating step performed by the user.

The device that stores the authentication data is separate from the terminal. This point gives the method a second advantage. The terminal may be shared between a plurality of users, to allow access to the service. However, the authentication data are not stored in the terminal but in a separate device. In a preferred situation, as will be seen below, a user will have a personal device at their disposal. In this case, which will be the standard manner of use of the method, the authentication data of a user will be stored in the personal device of the user and will not be able to be seen or used by users who share use of the terminal to access the service.

Another advantage of the method is that the authentication data present in the device may be used on a plurality of terminals. A user will therefore be able to change terminal and it will be possible for the user to retrieve their authentication data using a device in which they will have been stored.

The validating step belonging to a first embodiment gives the method another advantage, namely that the user will be able to control use of the authentication data belonging to them and that allow the user to access a service. The fact that these are stored in a device, which may also belong to the user, does not ensure sufficient protection in the absence of control of the use of the user's data by the user. This is because other users who have access to the device could extract authentication data from it with a view to using them to access the service by impersonating the legitimate user. To avoid this, the user is asked to perform a validating phase, which will allow the authentication data of the user to be extracted from the device, so that the user may access the service properly.

According to another particular mode of implementation of the invention, which may be implemented cumulatively with the preceding mode, the validating step comprises a prior step of storing a database of correspondences between user identifiers and respective identification data, and the validating step succeeds, which allows the device to provide the authentication data of a given user, after execution of the following steps:
the device obtaining an identification datum;
determining a user identifier corresponding in the stored database to the obtained identification datum;
verifying that the determined user identifier indeed corresponds to the given user.

By virtue of this mode, the validating step satisfactorily checks the identity of the user in order to guarantee that the authentication data of a given user are provided by the device only after a validation performed by said user. It is therefore indeed the legitimate user who validates use of her or his authentication data and their provision by the external device. If a malicious user ever gets her or his hands on the device of a given user, the validating phase such as specified in this embodiment will prevent the malicious user from accessing authentication data to which she or he is not entitled.

It is also possible, by virtue of this embodiment, to envision a mode of operation in which a separate device is shared between a plurality of users. In this case, the validating phase will make it possible to allocate to a given user the authentication data stored by the device that belong to her or him, in order to avoid incorrect allocation or data theft. In this embodiment, a device separate from the terminal is available to a plurality of users, and the authentication data of a given user are stored in a predetermined memory area of the device, which memory area is partitioned with respect to the other memory areas of the device, said determined memory area containing the authentication data of said user. In this way, access to one area of the device shared by a plurality of users does not allow access to the data of other users, said data being stored in other areas.

According to another particular mode of implementation of the invention, which may be implemented alternatively to or cumulatively with one or more of the preceding modes, the validating step comprises a prior step of storing a database of correspondences between terminal identifiers and respective identification data, and the validating step succeeds, which allows the device to provide the authentication data of a given user, after execution of the following steps:
the device obtaining an identification datum;
determining a terminal identifier corresponding in the stored database to the obtained identification datum;
verifying that the determined terminal identifier indeed corresponds to the given user.

In this embodiment, the validating step consists in the device verifying that it is indeed interacting with the expected terminal. The prior step of storing terminal identifiers may for example be carried out via a process of pairing the terminal and device. In all cases, the validating step will be performed by the user on the device: the validating step may consist just of the user plugging the device into the terminal, the device then verifying that it is interacting with the expected terminal.

The advantage of this embodiment may be to simplify the validating step. After a prior pairing step, the device will potentially provide the authentication data only after the device is presented to the terminal. In this way, the provision of authentication data is accelerated while remaining under the control of user, who indeed chooses the terminal to which she or he connects the device.

The two preceding embodiments may be combined. In this case, the validation consists in the device identifying both the user and terminal before supplying the authentication data. In this way, the security of this data is improved.

According to another particular mode of implementation of the invention, which may be implemented alternatively to or cumulatively with one or more of the preceding modes, the request to obtain authentication data of a user received by the device comes from the terminal; and the authentication data of a user provided by the device are provided to the terminal.

By virtue of this particular mode of implementation of the invention, when the user wishes to access the service from the terminal, the latter will make a request to the separate device in which the authentication data necessary for the user to access the service are stored, and the device will provide these data to the terminal after the validating step performed by the user on the device has taken place. The terminal will then be able to submit these authentication data to the service and, if they are correct, the user will indeed be able to access the service from the terminal.

According to another particular mode of implementation of the invention, which may be implemented alternatively to or cumulatively with one or more of the preceding modes, the request to obtain authentication data of a user received by the device comes from the terminal; and the authentication data of a user provided by the device are provided to the service.

By virtue of this mode of implementation, when a user wishes to access the service from the terminal, the latter will ask the device to provide the authentication data of the user and the device, after a validating step performed by the user, will send the authentication data necessary for the user to access the service directly to the service. The authentication data are sent directly from the device to the service, without passing through the terminal. This makes it possible to ensure greater protection of the authentication data with respect to the terminal. These data do not transit through the terminal, which may be shared between a plurality of users, to be submitted to the service, thereby preventing malware that could be installed on the terminal from accessing these authentication data with a view to transmitting them to malicious users.

According to another particular mode of implementation of the invention, which may be implemented alternatively to or cumulatively with one or more of the preceding modes, the request to obtain authentication data of a user received by the device comes from the service; and the authentication data of a user provided by the device are provided to the service.

In this embodiment, when a user attempts to access the service from the terminal, the service will contact the device directly and the device will supply it directly with the authentication data necessary for the user to access the service. This mode of implementation makes it possible to completely bypass the terminal when providing authentication data to the service, further increasing their security. Specifically, since the terminal may be shared between a plurality of users, it may be assumed that malicious software may be installed on it and allow these authentication data to be accessed with a view to transmitting them to malicious users. This embodiment, which bypasses the terminal, avoids this risk. Once the authentication data have been provided to the service, the user will be able to access the service and interact with it from the terminal.

According to another particular mode of implementation of the invention, which may be implemented alternatively to or cumulatively with one or more of the preceding modes, the request to obtain authentication data of a user received by the device comes from the service; and the authentication data of a user provided by the device are provided to the terminal.

By virtue of this mode of implementation, the service will make a direct request to the device to provide the authentication data of the user, but these data will transit through the terminal before being sent to the service. In this way, the user accesses the service more directly via the terminal. However, the direct request from the service makes it possible to accelerate the provision of the authentication data by the device.

According to another particular mode of implementation of the invention, which may be implemented alternatively to or cumulatively with one or more of the preceding modes, after the device has provided the authentication data to the terminal, the terminal uses the authentication data to complete the access requested to the service by a user from the terminal, then the terminal erases said authentication data from all the memory areas of the terminal.

By virtue of this mode of implementation, the managing method makes it possible to ensure connection of the user to the service from the terminal and at the same time ensures that the authentication data are not stored in the terminal. The authentication data, in this mode, only transit from the device via the terminal to the service, and are not kept in memory in the terminal. In this way, the risk of the authentication data being misappropriated from the terminal is limited and the security of the authentication data is improved.

According to another particular mode of implementation of the invention, which may be implemented alternatively to or cumulatively with one or more of the preceding modes, the step of the device providing the authentication data of a given user consists in the device displaying the data.

By virtue of this embodiment, the device displays the authentication data, the user being responsible for storing them and then transcribing them to obtain access to the service. The advantage of this embodiment is that it guarantees that the authentication data are never exported from the device and thus remain protected from any attackers.

According to another particular mode of implementation of the invention, which may be implemented alternatively to or cumulatively with one or more of the preceding modes, the prior step of storing authentication data of a user for the service is triggered by a direct interaction of the user with the device.

By virtue of this embodiment, the authentication data are entered directly by the user into the device. Once again, an advantage of this embodiment is that it ensures that the authentication data are never accessible outside of the device. These data are entered directly by the user into the device, which ensures their confidentiality and their protection from any attackers.

According to another particular mode of implementation of the invention, which may be implemented alternatively to or cumulatively with one or more of the preceding modes, the step of the device providing the authentication data of the user consists in a transfer of information relating to the authentication data of the user for various services to the terminal.

By virtue of this embodiment, it will be possible for the user to export a whole set of information relating to the authentication data to a terminal. This information may comprise authentication data, but will in general be limited to the identifiers of services the authentication data of which are stored in the device. In this way, it will be possible for a user to use a plurality of terminals to access services and to centralize the management of authentication data in a single device. The export of the information relating to the authentication data thus allows a user to change terminal while retaining her or his authentication data, since the latter remain centralized in the device. The device may manage the export of information relating to the authentication data by categorizing terminals into a number of distinct types (computers, tablets, smartphones), which for example makes it possible to have authentication data dedicated to one type of terminal. The user may thus select services for which she or he does not want the authentication data to be able to transit through the terminal.

In the modes described above, the step of the device providing authentication data takes place after the validating step has succeeded. Depending on the modes presented, this validating step may comprise identification of the user, identification of the terminal, or identification of both the user and the terminal.

According to a first hardware aspect, the invention relates to a system comprising a terminal capable of accessing a service, access to the service by a given user requiring the service to be provided with authentication data relating to said user, characterized in that the system further comprises a device separate from the terminal, and in that the terminal comprises a module for requesting the device to store authentication data of a user for the service and in that the device comprises the following modules:
a module for storing authentication data;
a module for providing stored authentication data.

By virtue of this hardware aspect, users are able to access a service via a terminal capable of being shared between a plurality of users, but since the terminal requests that the authentication data of the users be stored in separate devices, unauthorized access by users to authentication data other than their own on the terminal is not possible. The personal authentication data of the users are stored by devices separate from the terminal capable of being shared between the users, and the confidentiality of the authentication data cannot therefore be compromised as a result of the terminal used to access the service being shared between a plurality of users.

In addition, the device may be personal and dedicated to one given user, which allows this user to use a plurality of terminals yet manage the authentication data by using only one personal device and exporting the authentication data to various terminals depending on their type and on the needs of the user.

According to another hardware aspect, the system is characterized in that the terminal further comprises a module for requesting access to the service by a user and in that the device further comprises:
a module for receiving a request to obtain authentication data of a given user for the service;
a module allowing validation by a user of the provision of authentication data.

According to another hardware aspect, the invention relates to a computer program capable of being implemented by a terminal, the program comprising code instructions that, when it is executed by a processor, carry out the steps performed by the terminal of the managing method defined above.

According to another hardware aspect, the invention relates to a computer program capable of being implemented by a device, the program comprising code instructions that, when it is executed by a processor, carry out the steps performed by the device of the managing method defined above.

Lastly, according to another hardware aspect, the invention relates to data media on which computer programs comprising sequences of instructions for implementing the managing and accessing methods defined above are stored.

The data media may be any entity or device which is capable of storing the programs. For example, the media may comprise a storage means, such as a ROM, for example a CD-ROM or a microelectronic circuit ROM, or else a magnetic recording means, for example a hard disk. On the other hand, the media may be transmissible media such as an electrical or optical signal, which may be routed via an electrical or optical cable, by radio or by other means. The programs according to the invention may in particular be downloaded from the Internet. As an alternative, the information medium may be an integrated circuit into which the program is incorporated, the circuit being designed to execute or to be used in the execution of the method in question.

It is important to note that the description of the invention has been given here with reference to access by users to a service from a terminal, but the invention may of course also be applied in a situation where a terminal allows users to access a plurality of services. In this case, the authentication data must be allocated in such a way as to allow access by a given user to a given service, so that the separate devices provide appropriate data allowing access by a given user to a given service following a request for access to the service. These allocations of authentication data to various services are well known in the prior art, for example in modules allowing management of passwords by web browsers, and will not be described in greater detail here.

Likewise, the description of invention has been given here with reference to a terminal capable of being shared between a plurality of users. It will be understood that the invention also applies when a plurality of terminals are shared between a plurality of users, the number of terminals not equaling the number of users, as will be seen further on in the description. In particular, the invention may also be applied when a user uses a plurality of terminals to access various services. By virtue of the invention, the user can have a dedicated personal device with which they will be able to manage their authentication data in a single location instead of having to do it separately in the various terminals they use. In this way, the authentication data are always kept up to date, protected from any attackers, and the information relating to the authentication data is easily exportable to a new terminal when the user uses a new terminal.

### BRIEF DESCRIPTION OF THE DRAWINGS

The invention will be better understood on reading the following description, which is given by way of example and with reference to the appended drawings, in which:

FIG. 1 shows a system comprising a terminal allowing users to access a service, and a device separate from the terminal, the whole illustrating one example of embodiment of the invention.

FIG. 2 illustrates one example of steps implemented in the context of one embodiment of the invention.

FIG. 3 illustrates another example of steps implemented in the context of another embodiment of the invention.

FIG. 4 illustrates another example of steps implemented in the context of another embodiment of the invention.

FIG. 5 illustrates another example of steps implemented in the context of another embodiment of the invention.

FIG. 6 illustrates another example of steps implemented in the context of another embodiment of the invention.

FIG. 7 illustrates another example of steps implemented in the context of another embodiment of the invention.

FIG. 8 illustrates another example of steps implemented in the context of another embodiment of the invention.

### DETAILED DESCRIPTION OF ILLUSTRATIVE EMBODIMENTS

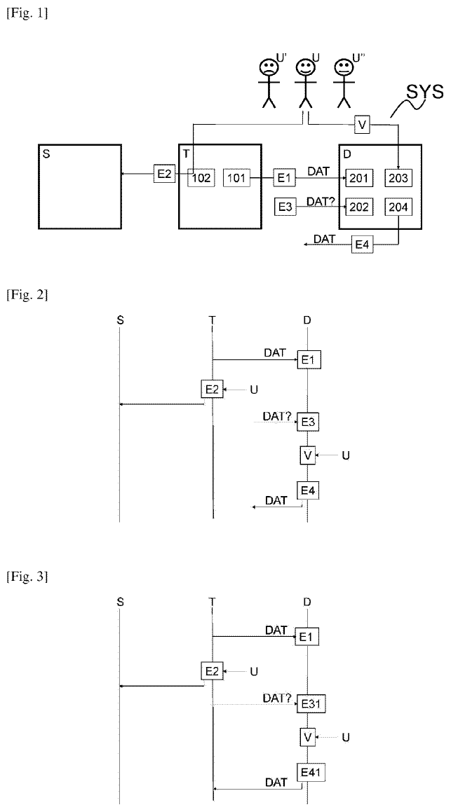

FIG. 1 shows a computer system SYS comprising a terminal T and a device D separate from the terminal T according to one particular embodiment of the invention. The terminal T is capable of being shared between a plurality of users U, U′, U″ in order to allow them to access a service S.

The service S is an information-technology service. It is rendered by a server (not shown in the figure). It may for example be a web service and will then be accessed via requests according to the HTTP protocol, and will provide its responses via the same protocol. The service S is accessed by users U, U′, U″ and must authenticate the users U, U′, U″ in order to provide information and carry out actions appropriate for a given user U. A given user U is authenticated by providing the service with authentication data DAT belonging to a given user U. These authentication data DAT will in general consist of a pair made up, on the one hand, of an identifier of the given user U and, on the other hand, of a password known to the user U. The service S will then verify that the password provided in the authentication data DAT is indeed the one expected for the given user U and will then allow the user U to access the service S. Other authentication data DAT may be, for example, data relating to a biometric identification. The service S, rather than being accessible by a web browser, could be accessible from a smartphone-type terminal via a mobile application that queries the service S hosted by a remote server. The mobile application will then have to provide a password, this password either being stored in memory by the application or provided by the user U as the case may be. In the case where the service S is a web service, or indeed is accessible by a mobile application, the authentication data DAT may instead comprise one or more authentication tokens which record a past connection of the user U to the service S and the permission given to connect to the service S only by presenting the authentication token without providing the password again. The service S may also be a service such as the provision of an API (acronym of Application Programming Interface) and the authentication data could then be data such as passwords or encryption keys required by the API to be able to access it and make requests thereto, or indeed even authentication tokens. These concepts are well known in the prior art and neither the nature of the service S nor that of the authentication data DAT will be described in greater detail.

The terminal T will in general be a computer. It could also be a tablet or a smartphone, but in all cases the terminal T has the hardware architecture of a conventional computer. It in particular comprises a processor, a RAM (acronym of Random-Access Memory) and a ROM (acronym of Read-Only Memory) such as a flash memory (not shown in the figure) and input/output devices such as keyboards and/or screens (not shown in the figure).

The terminal T allows the users U, U′, U″ to access the service S. To do this, the terminal T will first allow the users U, U′, U″ to manage their respective authentication data DAT.

As has already been seen, in the prior art, the terminal T is for example a computer that allows access to the service via a web browser, and passwords are managed via a dedicated module of the browser. In the present invention, certain elements of such a dedicated module may be preserved, such as for example an element for randomly generating passwords or indeed for detecting service interfaces requesting provision of passwords. These elements are well known in the prior art and are not described in greater detail.

According to the invention, the terminal T comprises a module 101 for requesting that the device D store E1 authentication data DAT of a given user U. This module will for example work with a dedicated module for managing passwords that is present in the web browser of the terminal T.

When a user U signs into the service S for the first time, the web browser of the terminal T will be able to detect the password created by the user U, or will be able to suggest one to the user. However, according to the invention, the device D separate from the terminal T will be asked E1 by the module 101 of the terminal T to store the password of the user U. This will also occur each time the password of the user U for the service S is modified and in general at any time when it is relevant to store E1 authentication data DAT.

In this way, the invention makes it possible to store the authentication data DAT outside the terminal T, which is capable of being shared by the users U, U′, U″. By virtue of this storage outside the terminal T, the authentication data DAT are better protected from any malicious users seeking to access the service S instead of a given user U.

In embodiments, the authentication data DAT allowing a user U to access the service S from a terminal T comprise elements allowing the service S to be identified. These elements will for example allow a service S to be automatically identified so that, when a request for the authentication data DAT is made to the device D, only those concerning access to the service S are provided.

In embodiments, the authentication data DAT allowing a user U to access the service S from a terminal T comprise elements allowing the terminal T to be identified. These elements may for example be a MAC address (MAC being the acronym of Media Access Control) or an IMEI number (IMEI being the acronym of International Mobile Equipment Identity). The identifier of the terminal T added to the authentication data DAT will again allow the device to filter the authentication data DAT provided depending on the terminal T to which they relate. Categories of terminals T may also be identified in order to classify the authentication data DAT according to the types of terminals T for which they are requested.

The terminal T also comprises, in certain embodiments, a module 102 for requesting E2 access to the service S by a user U. The module 102 may for example be a component of a web browser by means of which the user U will access the service S.

The system SYS also comprises a device D separate from the terminal T.

The device D comprises elements (not shown in FIG. 1), such as a processor, a RAM (acronym of Random-Access Memory) and a ROM (acronym of Read-Only Memory) such as a flash memory (not shown in the figure), in order to be able to carry out the operations according to the invention.

The device D could for example be a computer separate from the terminal T, or indeed a smartphone. However, many other embodiments are also possible. For example, the device D could be a dedicated device allocated to a given user U. This device D could be dedicated solely to performing the operations according to the invention, namely the storage E1 of authentication data DAT and their provision E4 in due course after validation V. The device D could also perform certain functions in addition to those of the invention. For example, the device D allocated to a given user U could be a pointing device such as a mouse that the user U will connect to the terminal T when she or he wishes to implement the invention, and which will serve the user both as a pointing device for the terminal T and as a device implementing the invention. In this embodiment of the invention, the terminal T is shared between a plurality of users U, U′, U″, each of whom has a separate device D allocated to them.

The device D allocated to the user U may also be a USB key (USB being the acronym of Universal Serial Bus) allowing any type of data to be stored.

The device D may or may not comprise components such as keyboards or screens that allow the user U to interact directly with the device D. Certain embodiments of the invention require the presence of such interaction components and will be indicated as doing so below.

Of course, some users may not have a device D and will therefore have to manage and store their authentication data DAT using one of the methods of the prior art.

The device D comprises a module 201 for storing E1 authentication data DAT of a user U for the service S.

As was seen above, the module 101 of the terminal T will ask the device D to store E1 authentication data DAT, for example when the user U creates her or his password for the service S, or indeed when this password is modified, or at any time when this storage E1 is relevant. The storage E1 may also be requested by the terminal T when the latter receives an authentication token provided by the service S to allow subsequent connection of the user U. It is the module 201 of the device D separate from the terminal T that carries out this storage E1. In FIG. 1, the operation E1 of storing the authentication data DAT is shown by an arrow between the module 101 of the terminal T which requests this storage E1, the arrow being labeled E1 and bearing the word DAT.

In one embodiment, the prior step of storing E1 authentication data DAT of a user U for the service S is triggered by a direct interaction of the user U with the device D. In this mode, the device D comprises elements (not shown in FIG. 1) allowing an interaction with the user U, such as a keyboard, a screen, or a microphone to allow voice interaction. The screen may be a touchscreen, and in this case it may be possible to provide a virtual keyboard. The device D in this case may for example be a smartphone, but other forms are possible for a device D dedicated to the invention. The device D may have the format of a credit card and be equipped in addition with a keyboard and with a screen of limited size, allowing only the input of authentication data DAT. The device D may also play the role of a pointing device (mouse or the like) and may also be provided with a screen and a keyboard of small size, the user interface being limited to the input of authentication data DAT.

In all cases, by virtue of this module 201, the authentication data DAT are stored outside the terminal T, which is capable of being shared between a plurality of users U, U′, U″, which improves the protection of these data.

The device D also comprises, in certain embodiments, a module 202 for receiving E3 a request to obtain the authentication data DAT of the given user U for the service S. In FIG. 1, the reception E3 of a request to obtain the authentication data DAT is shown by an arrow bearing the word DAT?, the question mark symbolizing the request for the authentication data DAT.

The device D also comprises, in certain embodiments, a module 203 allowing validation V by a user U on the device D.

This validating step V occurs following a request for access to the service S by a given user U. This access will require submission to the service S of the authentication data DAT of the user U for the service S. There is therefore a need for a validating operation V to be carried out by means of the module 203 of the device D to justify the subsequent provision of the authentication data DAT.

The device D also comprises a module 204 for providing E4 authentication data DAT.

In certain embodiments, once the validating operation V has been performed, and has succeeded, the device D will proceed to provide E4 the authentication data of the user U for the service S.

In one embodiment, the step of the device D providing E4 the authentication data DAT of a given user U consists in the device D displaying the data DAT. In this embodiment, the device D comprises a display means (not shown in FIG. 1) such as a screen of greater or lesser size. When the device D is a smartphone, the screen used to display and hence provide E4 the authentication data DAT is present. The device D may also be a device dedicated to the invention, in the format of a credit card with a screen of small size which will be able to be used to display and hence provide E4 the authentication data DAT. This may further be the case when the dedicated device D also takes the form of a pointing device, or a USB memory stick. In the case where the providing step E4 is carried out by displaying the authentication data DAT, it is the user U who will then provide the authentication data DAT to the service S via the terminal T, in order to complete her or his access to the service S from the terminal T. This provision is achieved via the interacting means of the terminal T. The advantage of this embodiment is that the authentication data DAT remain stored in the dedicated device D and therefore remain protected.

In order to carry out the various steps of the managing method according to the invention, communication links must be set up on the one hand between the elements of the system SYS and the service S, and on the other hand within the system SYS.

The service S is an information-technology service. The service S is rendered by a computer server (not shown in FIG. 1). The nature of the server rendering the service S is irrelevant to the invention. It may be a server present in a cloud, or a dedicated computer. The service S is accessed by the user U from the terminal T. The service S may be a web service, and in this case interactions with the service S occur by means of the HTTP protocol, through a web browser executed in the terminal T. The link between the terminal T and the server rendering the service S must, in this context, make it possible to implement the HTTP protocol between the terminal T and the service S. The service S may for example be accessed via the Internet, and the terminal T will then have to be able to access the Internet. The service S may also be hosted in a server and accessed through a mobile application hosted in a smartphone-type terminal T. In this case, the link between the terminal T and the server S will then use the HTTP protocol for the most part, but could also use an ad hoc protocol routed via the Internet. In certain contexts, the service S will be accessible via a corporate intranet, and the terminal T will belong to the same intranet.

In particular contexts, it is conceivable for the service S to be accessed via a direct link between the terminal T and the service S. For example, the service S may only be accessible via the terminal T, with a direct link being set up between the terminal T and the service S. This link may be wireless or wired, as the case may be. Wireless links may be set up using Wi-Fi or Bluetooth protocols, or by virtue of mobile telephony standards such as GSM, EDGE, UMTS, 3G, 4G or 5G, inter alia. Wired links may for example be a serial link between a terminal T and a server hosting the service S. The communication protocol between the terminal T and the service S may then remain the HTTP protocol or else be a completely ad hoc protocol. The service S may for example be an API (acronym of Application Programming Interface) and protocols such as SOAP, JSON, CORBA (acronyms of Simple Object Access Protocol, JavaScript Object Notation and Common Object Request Broker Architecture, respectively) inter alia may be used on wired or wireless links to exchange data between the terminal T and the service S.

In certain contexts, the service S will be a software package executed directly in the terminal T. In this case, the link between the terminal T and the service S is a link internal to a computer, using the various components of the terminal T (data bus, link between keyboard and processors).

The device D for its part is separate from the terminal T. The link between the terminal T and the device D may be formed in a number of ways. In one embodiment, the terminal T will be accessible via the Internet and the links between the terminal T and the device D will be formed of HTTP requests or other types of request addressable over the Internet. In other cases, the terminal T and the device D will belong to the same corporate intranet, or else to the same LAN (acronym of Local Area Network). Communications may then occur via a wireless link such as a Wi-Fi or Bluetooth link. In other cases, lastly, the device D will take the form of a pointing device or of a USB key and will be physically connected to the terminal T to form the link between the terminal T and the device D. The link will then be formed via the communication bus of the terminal T and will use the USB protocol.

In all the embodiments, the links within the system SYS, on the one hand, and the links between the system SYS and the service S, on the other hand, may be formed using communication protocols ensuring the encryption of the data exchanged by means of said communication protocols. Such protocols are for example HTTPS, but also FTPS, SSH and SFTP (acronyms of File Transfer Protocol Secure, Secure Shell and SSH File Transfer Protocol, respectively). In this way, the authentication data DAT are protected against the risk of interception when they are exchanged in the storing step E1 and providing step E4.

The method comprises a step of the terminal T requesting the device D to store E1 authentication data DAT. This storage E1 may be achieved simply by storing the authentication data DAT in a memory area of the device D. If the device D stores the authentication data of a plurality of users U, U′, U″, one partitioned memory area may be assigned to each user to improve the protection of the authentication data DAT.

In one embodiment, the step of storing E1 authentication data DAT of a user U for the service S is triggered by a direct interaction of the user U with the device D. This mode requires the device D to comprise interacting means such as a keyboard, screen or microphone to allow the user U to interact with the device D. Depending on the form taken by the device D (smartphone or dedicated device possibly performing other functions), the size of the interacting means will vary, but in general they will be small in size.

In certain embodiments, the device D will use cryptographic tools to further protect the authentication data DAT stored by the device D. In this way, the protection of the authentication data DAT will be improved.

One possible embodiment using cryptography is to have the device D encrypt the authentication data DAT in the storing step E1 carried out by the module 201. In this way, the authentication data DAT will be kept encrypted, which decreases the risk that these data will be accessed by illegitimate users. The encryption carried out here may use a symmetric key, and the decryption of the authentication data DAT may then be performed in the providing step E4 carried out by the module 204 of the device D. In the case of symmetric encryption and decryption, the device D will use the same symmetric encryption key for both operations. If a device D stores authentication data of a plurality of users U, U′, U″, an additional precaution will be to assign a different key to store the authentication data DAT of different users. This precaution will be combined with the precaution of using memory areas that are partitioned from one another and allocated to the various users U, U′, U″.

Other embodiments using cryptography could use asymmetric encryption, employing a pair of so-called public and private keys. In one of these embodiments, the terminal T uses a public key to encrypt the authentication data DAT of the user U before the step of requesting storage E1 by the device D. The corresponding private key could then be held by the device D, which would use it to decrypt the authentication data DAT in the providing step E4. As above, one pair of public/private keys may be used per given operator U to improve the protection of the authentication data in the case where the device D stores the authentication data DAT of a plurality of users.

In certain embodiments using cryptography, the terminal T may manage the encryption and decryption of the authentication data DAT of the users U, U′, U″ entirely. These embodiments may use symmetric or indeed asymmetric encryption techniques. In these embodiments, the additional protection of the authentication data DAT provided by the encryption is present, and, moreover, the device D does not have to perform encryption or decryption operations. In this way, the device D is able to remain a device that is as simple as possible, with limited computing power, not required to perform encryption/decryption operations, but merely preforming the operations of storing E1 encrypted authentication data DAT and of providing E4 the same encrypted data.

Once the step of requesting storage E1 of authentication data DAT has been carried out, the managing method may be implemented to allow access to the service S by a user U from the terminal T.

The method comprises, in certain embodiments, a step E2 of requesting access to the service S by a given user U. This request may be made in a number of ways. In the case where the service S is a web service, the user U will interact with a web browser running on the terminal T, which browser will send HTTP requests to the service S. The service S may also be a computer application, and in this case a dedicated man-machine interface in the terminal T will allow the user U to request E2 access to the service S.

To complete access to the service S, the authentication data DAT are required. The next step of the method is, in certain embodiments, the reception E3 by the device D of a request to obtain the authentication data DAT of the given user U for the service S.

Depending on the nature of the device D, the reception E3 of the request to obtain the authentication data may take a plurality of forms. If the device D is a smartphone, the link with the device D may be a wireless link and the reception E3 may be reception of a web request. Other protocols may be envisioned such as sending a JSON file (JSON being the acronym of JavaScript Object Notation) to be completed by the device D. In the case where the device D is a device dedicated to the method (modified pointing device, modified USB key, device taking the form of a credit card), it may be connected by means of a Bluetooth link or else a wired link as seen above.

The reception E3 of the obtain request may then use this Bluetooth or wired link. The communication protocol using the link may be an ad hoc communication protocol.

In order for the device D to provide E4 the authentication data DAT, a step of validation V by the user U is requested in certain embodiments. The validating step V may take a plurality of forms.

In one embodiment, the validation V may be limited to a simple operation, such as clicking on a button of a dedicated window, if the device D comprises the human-machine interface allowing the user U to carry out this interaction, namely a screen and a pointing device. In one embodiment, the validation V may consist in submission by the user U to the device D of a personal identification code. This mode also requires a particular human-machine interface, namely here at least a screen and a keyboard.

In an even simpler embodiment, the validating step V may consist in pressing a button or any other simple physical device with which a user U may interact, such as a switch, or a cursor, or a zone receptive to the pressure of a body part. In this case, provision will be made for the device D to be allocated to one given user U. In this mode, the device D separate from the terminal T will store the authentication data DAT for only one given user U.

The device D may take any type of form. It may for example take the form of a credit card, and optionally comprise, in addition to a mechanism allowing the validation V (button, switch, slide or any other equivalent mechanism), lights indicating the need for validation V and the success thereof. The device D may also take the form of a USB key (USB being the acronym of Universal Serial Bus) able to store E1 the authentication data DAT, which key will have been modified to be able to perform a validating operation V and a providing operation E4 following the validation V.

In these embodiments, in which the validation V performed by the user U on the device D is very simple, there is a risk of impersonation. Specifically, a user among the users U, U′, U″ could purloin the device D allocated to a given user U, request access to the service S via the terminal T using the identity of the user U, and carry out the validation V in her or his place using the device D, when the validation V consists of a simple gesture as in the modes described above.

To avoid this risk of impersonation, one embodiment of the validating step V (not shown in FIG. 1) will consist in the validating step V comprising a prior step of storing a database of correspondences between user U identifiers and respective identification data, and in the validating step V succeeding, which allows the device to provide the authentication data DAT of a given user U, after execution of the following steps:
the device D obtaining an identification datum;
determining a user U identifier corresponding in the stored database to the obtained identification datum;
verifying that the determined user U identifier indeed corresponds to the given user U.

In this way, the authentication data DAT of a given user U are provided by the device D only when it is indeed the user U who is carrying out the validating step V on the device D separate from the terminal T. There are a number of ways in which this variant of the validating step V may be carried out, depending on the capabilities of the device D.

In one embodiment, the device D may be a computer or a smartphone and comprise human-machine interfaces such as a screen and a (real or virtual) keyboard. The identification data stored and obtained by the device D may then be a password, and the user U will be identified by means of this password in the validating step V.

In another embodiment, the device D has capabilities allowing verification of biometric characteristics of the users U, U′, U″. Such capabilities are for example well known on computers and smartphones, with fingerprint readers integrated into the computer or smartphone, or iris readers using the cameras of the computer or smartphone, or devices for recognizing the speaker using the microphones of the computer or smartphone. Other verification capabilities are also possible. A very simple device D, of credit-card format, dedicated to the invention, may also have a capability allowing verification of biometric characteristics, and first and foremost a fingerprint reader. A device D may also be a peripheral of the terminal T and for example serve the user U as a device for pointing on the terminal T. A biometric verification capability may be integrated into such a device D, for example a fingerprint reader, or else a verifier of the transmission of electrical signals through the human body.

The presence of capabilities allowing verification of biometric characteristics in the device D makes it possible to make the validating step V easy to execute and convenient for the user U. In addition, the verification of biometric characteristics makes it possible to ensure that it is indeed the user U who is performing the validating step V which, when it succeeds, allows the device D to provide the authentication data DAT of the user U for the service S. In this way, by virtue of this embodiment, it becomes more difficult for a user other than U to access the authentication data DAT of U, and these are protected more effectively.

In one embodiment, the validating step V comprises a prior step of storing a database of correspondences between terminal identifiers and respective identification data, and the validating step V succeeds, which allows the device D to provide E4 the authentication data DAT of a given user U, after execution of the following steps:
the device D obtaining an identification datum;
determining a terminal identifier corresponding in the stored database to the obtained identification datum;
verifying that the determined terminal identifier indeed corresponds to the terminal T.

In this mode, the validating step V comprises identification of the terminal T by the device D. Such identification may be achieved using the Bluetooth protocol. The device D will then, in a prior phase, be paired with the terminal T. When authentication data DAT must be provided E4, they will be able to be provided only after a Bluetooth link has been set up between the device D and the terminal T. Setting up this link involves identification of the terminal T by the device D. In this way, the authentication data DAT are provided E4 only to a terminal T previously paired with the device D and then identified in the validating step V.

The identification of the terminal T may be in addition to the identification of the user U, or indeed alternatively to the identification of the user U. For example, the validating step V may be limited to an interaction without identification of the user U (the user presses a button of the device D) and instead comprise an identification of the terminal T limiting the provision E4 of authentication data DAT to a terminal T previously paired with the device D. However, in another mode, the validating step V comprises both identification of the user U (the user must for example provide a password to the device D, or their biometric characteristics must be recognized) and identification of the terminal T (the authentication data are only provided E4 to a terminal T previously paired with the device D).

In certain embodiments, once the validating step V has succeeded, the device D may proceed to provide E4 the authentication data DAT of the user U for the service. As for step E3, the way in which this step E4 is carried out will depend on the communication link allowing interaction with the device D. If the method uses cryptography techniques, step E4 may comprise a phase of decrypting the authentication data DAT as seen above.

FIG. 2, for its part, describes the succession of the steps according to embodiments of the invention.

In one step, the terminal T will ask the device D to store E1 authentication data DAT. This step takes place when a user U creates new authentication data DAT with a view to signing in to the service S from the terminal T. This may for example occur when an account of the user U is created for the service S, or when the password used to access the service S is changed.

A user U will at some point make a request E2 to access the service S from the terminal T. The device will then receive E3 a request to obtain the previously stored E1 authentication data DAT.

The user U will then have to perform a validating step V on the device D. When the validating step V succeeds, the device D proceeds to a step of providing E4 the authentication data DAT allowing the user U to access the service S.

The following figures detail the participants in the different steps.

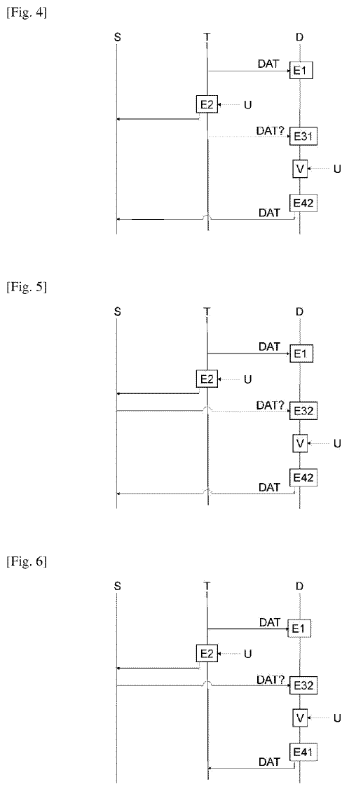

FIG. 3 shows one possible embodiment of the method.

In this mode, it is the terminal T that makes the request to obtain the authentication data DAT that is received E31 by the device. Next, after validation V, the device D provides E41 the authentication data DAT to the terminal T. The latter will then transfer them to the service S in order to complete the request E2 to access the service S by the user U from the terminal T.

This embodiment may particularly be used in the context where the terminal T is a smartphone and the service S is accessed through a mobile application that runs in the terminal T, or when the service S is a web service and is accessed from the terminal T through a web browser. In these contexts, in order for the user U to be able to access the service S, the terminal T will have to provide either a password, or an authentication token indicating a previous connection of the user U, which will be considered sufficient by the service S. Such elements (password or token) form the authentication data DAT. These elements, and in particular authentication tokens, may be stored in the terminal T to avoid having to ask the user U for a password again. However, the presence of authentication data DAT in the terminal T is a security risk.

In embodiments of the invention, the authentication data DAT are received by the terminal T after the provision E41 by the device D, used by the terminal T to complete the access by the user U to the service S, then erased by the terminal T from all the memory areas of the terminal T where the authentication data DAT could have been written. The advantage of these embodiments is to guarantee that the authentication data DAT are not stored in the terminal T after they have been used, which eliminates a security risk stemming from these authentication data DAT.

FIG. 4 shows another possible embodiment of the method.

In this mode, it is the terminal T that makes the request to obtain the authentication data DAT that is received E31 by the device. Next, after validation V, the device D provides E42 the authentication data DAT directly to the service S. One advantage of this embodiment is that the authentication data DAT are provided to the service S more rapidly, in order to accelerate access by the user U to the service S.

FIG. 5 shows another possible embodiment of the method.

In this mode, it is the service S that makes the request to obtain the authentication data DAT that is received E32 by the device. Next, after validation V, the device D provides E42 the authentication data DAT directly to the service S. One advantage of this embodiment is that it avoids the need for the authentication data DAT to transit through the terminal T. As the latter is shared between the users U, U′, U″, malicious users may have installed spyware in the terminal T that could misappropriate the authentication data DAT. This embodiment avoids this risk.

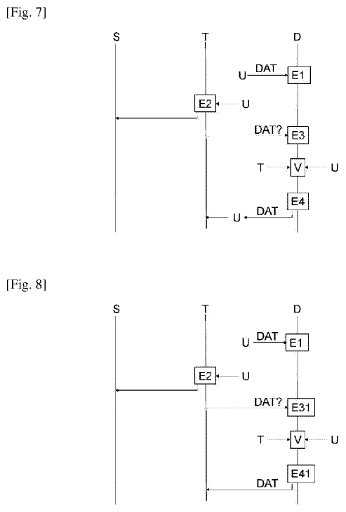

FIG. 6 shows another possible embodiment of the method.

In this mode, it is the service S that makes the request to obtain the authentication data DAT that is received E32 by the device. Next, after validation V, the device D provides E41 the authentication data DAT to the terminal T. This embodiment combines the rapidity of the direct request for the authentication data DAT by the service S with the convenience of providing the authentication data DAT to the terminal T through which the user U accesses the service S.

As already seen in the description of FIG. 3, in certain embodiments, the terminal T will erase the authentication data DAT after the provision E41 and the use of the authentication data DAT by the terminal T to complete the access to the service S by the user U.

FIG. 7 shows another possible embodiment of the method.

In this mode, the step of storing E1 authentication data DAT is triggered by an interaction of the user U with the device D. The device D will for example have a keyboard and a screen that will allow the user U to enter the authentication data DAT into the device D that will then store them E1.

During a subsequent request by U to access E2 the service S from the terminal T, it will be necessary to access the authentication data DAT. The terminal T makes a request for these authentication data DAT, which request is received E3 by the device D. The validating step V comprises, in this embodiment, a step of identifying the terminal T. This identification may have be prepared for in advance, for example, by Bluetooth pairing between the device D and the terminal T. The device D, recognizing the terminal T in the validating step V, may proceed to provide E4 the authentication data DAT.

In this embodiment, the provision E4 of the authentication data DAT consists in displaying the data to the user U. In this embodiment, the device D therefore has a screen that will allow it to display the authentication data DAT. The user U will then be able to read the authentication data DAT on the screen of the device D before personally entering them into the terminal T, which will allow the user to proceed to access the service S from the terminal T.

FIG. 8 shows another possible embodiment of the method.

In this mode, as in the embodiment described above, the step of storing E1 authentication data DAT is triggered by an interaction of the user U with the device D. As in the preceding mode, the validating step V comprises an identification of the terminal T. The fact that the terminal T is identified provides an additional security guarantee. The device D then provides E41 the authentication data DAT directly to the terminal T. The latter may then use the authentication data DAT to obtain access by the user U to the service S from the terminal T.

It will moreover be noted that the above description refers to a single service S. However, the invention described in the present patent application may equally be applied when the users U, U′, U″ seek to access a plurality of services S, S′, S″. The authentication data DAT referred to here are understood as being used by a given user U to access a given service S.

Several authentication data DAT may be stored E1 for the same user U in the device D, the various authentication data DAT serving to access various services S, S′, S″. Identification elements of the services S, S′, S″ are then included in the authentication data DAT in order to allow the device D to recognize the data DAT that it must provide E4 depending on the attempts made by the user U to access a given service S.

In embodiments, the providing operation E4 may consist in exporting information relating to a plurality of sets of authentication data DAT to a terminal T. The exported information may relate to all the authentication data DAT present in the device D, or only relate to some of them. This export allows the user U to manage her or his authentication data DAT outside the terminals T with which she or he will access the services S. The information relating to the authentication data DAT is known to the terminal T and allow the latter to make a request to the device D with a view to obtaining the authentication data DAT that the terminal T needs. The various terminals T will be identified and categories of terminals T may be defined to facilitate management of the authentication data DAT by the user U. For example, certain data will be configured for a connection from computer-type terminals T and other data will be configured for smartphone-type terminals T.

Exporting information relating to the authentication data DAT also makes it possible to provide an answer to the problem of transferring use of the authentication data DAT to a new terminal T. When a user U has a new terminal T, she or he will export information relating to the authentication data DAT to this new terminal, while applying a filter based on terminal type if necessary. This information relating to the authentication data DAT will then allow the new terminal T to interact with the device D, in order to request said authentication data DAT when necessary.

Lastly, it will be noted here that, in the present text, the term “module” may correspond equally to a software component or to a hardware component or to a set of software and hardware components, a software component itself corresponding to one or more computer programs or subroutines or, more generally, to any element of a program able to implement a function or a set of functions as described for the modules in question. In the same way, a hardware component corresponds to any element of a hardware assembly able to implement a function or a set of functions for the module in question (integrated circuit, chip card, memory card, etc.).

Although the present disclosure has been described with reference to one or more examples, workers skilled in the art will recognize that changes may be made in form and detail without departing from the scope of the disclosure and/or the appended claims.

1. A managing method for comprising:
managing authentication data allowing access to a service by a user from a terminal, access by a given user to a service requiring the service to be provided with authentication data relating to said given user, wherein the managing comprises:
said terminal requesting that a device separate from the terminal store authentication data of the given user for the service followed by,
the device providing the stored authentication data of the given user for the service.

2. The managing method as claimed in claim 1, wherein providing the stored authentication data of the given user for the service is preceded by: a request by the given user to access the service from the terminal; a the device receiving a request to obtain authentication data of the given user for the service; and a validating performed by the given user on the device.

3. The managing method as claimed in claim 2, wherein the validating comprises a prior step of storing a database of correspondences between user identifiers and respective identification data, and wherein the validating succeeds, which allows the device to provide the authentication data of the given user, after execution of the following steps:
the device obtaining an identification datum;
determining a user identifier corresponding in the stored database to the obtained identification datum; and
verifying that the determined user identifier corresponds to the given user.

4. The managing method as claimed in claim 2, wherein the validating comprises a prior step of storing a database of correspondences between terminal identifiers and respective identification data, and the validating step succeeds, which allows the device to provide the authentication data of the given user, after execution of the following steps:
the device obtaining an identification datum;
determining a terminal identifier corresponding in the stored database to the obtained identification datum; and
verifying that the determined terminal identifier indeed corresponds to the terminal.

5. The managing method as claimed in claim 2, wherein:
the request to obtain authentication data of the given user received by the device comes from the terminal; and
the authentication data of the given user provided by the device are provided to the terminal.

6. The managing method as claimed in claim 2, wherein:
the request to obtain authentication data of the given user received by the device comes from the terminal; and
the authentication data of the given user provided the device are provided to the service.

7. The managing method as claimed in claim 2, wherein:
the request to obtain authentication data of the given user received by the device comes from the service; and
the authentication data of the given user provided the device are provided to the service.

8. The managing method as claimed in claim 2, wherein:
the request to obtain authentication data of the given user received by the device comes from the service; and
the authentication data of the given user provided the device are provided to the terminal.

9. The managing method as claimed in claim 5, further comprising, after the device has provided the authentication data to the terminal, the terminal using the authentication data to complete the access requested to the service by the given user from the terminal, then the terminal erasing said authentication data from all the memory areas of the terminal.

10. The managing method as claimed in claim 1, wherein providing the authentication data of the given user consists comprises in the device displaying the data.

11. The managing method as claimed in claim 1, wherein the requesting that the device stores authentication data of the given user for the service is triggered by a direct interaction of the given user with the device.

21. The managing method as claimed in claim 1, wherein providing the authentication data of the given user comprises a transfer of information relating to the authentication data of the given user for various services to the terminal.

13. A system comprising:
a terminal capable of accessing a service, access to the service by a given user requiring the service to be provided with authentication data relating to said given user;
a device separate from the terminal, wherein
the terminal comprises at least one first processor and at least one first non-transitory computer readable medium comprising first instructions stored thereon which when executed by the at least one first processor configure the terminal to:
request the device to store authentication data of the given user for the service, and
the device comprises at least one second processor and at least one second non-transitory computer readable medium comprising second instructions stored thereon which when executed by the at least one second processor configure the device to:
store authentication data; and
provide stored authentication data.

14. The system as claimed in claim 13, wherein the first instructions further configure the terminal to request access to the service by the given user and the second instructions further configure the device to:
receive a request to obtain authentication data of the given user for the service; and
allow validation by the given user of the provision of authentication data.

15. (canceled)

16. (canceled)

17. A set of at least two non-transitory computer readable data media on which computer programs are stored that when executed implement the managing method defined in claim 1, the computer programs comprising a first program stored on a first data medium and comprising code instructions that, when executed by a first processor, carry out the requesting performed by the terminal and a second program comprising code instructions that, when executed by a second processor, carry out the providing performed by the device.

18. (canceled)

19. The managing method as claimed in claim 8 further comprising, after the device has provided the authentication data to the terminal, the terminal using the authentication data to complete the access requested to the service by the given user from the terminal, then the terminal erasing said authentication data from all the memory areas of the terminal.
